(19) United States
(12) Patent Application Publication
(10) Pub. No.: US 2009/0199913 A1
(43) Pub. Date: Aug. 13, 2009

(54) Valve Device With Pressure Regulator

(75) Inventor: Vito Doscioli, Concesio (IT)

Correspondence Address: KILYK & BOWERSOX, P.L.L.C., 400 HOLIDAY COURT, SUITE 102, WARRENTON, VA, 20186, US

(73) Assignee: CAMOZZI S.P.A SOCIETA UNIPERSONALE, Brescia (IT)

(21) Appl. No.: 12/325,430

(22) Filed: Dec. 1, 2008

(30) Foreign Application Priority Data
Feb. 7, 2008 (IT) BS2008A000025

(51) Int. Cl. F16K 15/00

(52) U.S. Cl. 137/528

(57) ABSTRACT

The subject of this invention is a valve device with pressure regulator (14), in particular for use in a valve island (100). The valve device consists of a base (10), at least one pilot valve (34) and a valve body (12) in which a sliding shuttle valve element is housed. The pressure regulator extends from one of the lateral surfaces of the valve body. The latter consists of an interception portion, and a regulation portion which conveys the incoming fluid from the base to the regulator and from the regulator to the interception portion. The regulation portion extends parallel to and at the side of the interception portion, which is to say along the development direction of the valve island. Advantageously, the regulator does not alter the height occupied by the valve device and has no effect on electrical hook-up of the pilot valve to the base.

### FIELD OF THE INVENTION

The subject of this invention is a valve device with pressure regulator, in particular for use in a valve island.

### BACKGROUND ART

In certain applications envisaging the use of valves forming an island or battery of valves there is a need to individually regulate the pressure of a fluid outgoing from a valve device towards its respective actuator, for example a pneumatic cylinder.

To meet this requirement several solutions have been proposed which envisage associating a pressure regulator with an individual valve device, for example one intended to form or be mounted on a valve island.

A well known and widespread solution is described, for example, in EP 869418 A. This implementation discloses to insert the pressure regulator between the body of a valve device and a base containing fluid feed conduits at unregulated pressure, discharge conduits and any outlet conduits. This device is known as a sandwich regulator.

However, these well known devices have certain drawbacks. In the first place, the valve device and therefore the whole island occupies greater space in height. In the case of a valve island with electrical cabling integrated in the base, the height increase of the valve body means that a special connection or bridge has to be provided to carry the electrical signal from the base to the valve. Moreover, the valve device with regulator consists of a great number of particulars to be assembled.

The purpose of this invention is to supply a valve device, in particular for use in a valve island, which at least partially obviates the drawbacks referred to above in connection with the state of the art.

### SUMMARY OF THE INVENTION

This purpose is achieved by means of a device in accordance with claim 1 and a valve island in accordance with claim 20. The depending claims describe preferred embodiments of the invention.

### BRIEF DESCRIPTION OF THE DRAWINGS

Further features and advantages of the device according to the invention will be clear from the description below of preferred examples thereof, with reference to the attached figures where:

FIG. 1 illustrates a perspective exploded view of a device in accordance with the invention;

FIG. 2 is a plan top view of the device;

FIG. 3 is an end elevation view of the device;

FIG. 4 is an elevation view in partial section of the valve device;

FIG. 5 is a longitudinal section of the device along line A-A of FIG. 2;

FIG. 6 is a transversal section of the device at the level of the feed conduit (line C-C in FIG. 7);

FIG. 7 is a section of the device along line B-B in FIG. 6;

FIG. 8 is a longitudinal section along line D-D in FIG. 7;

FIGS. 9 and 10 are section and partial section views of the device in accordance with line E-E in FIG. 7;

FIG. 11 is a section of the device along line F-F in FIG. 8; and

FIG. 12 illustrates a valve island including a valve device in accordance with the invention.

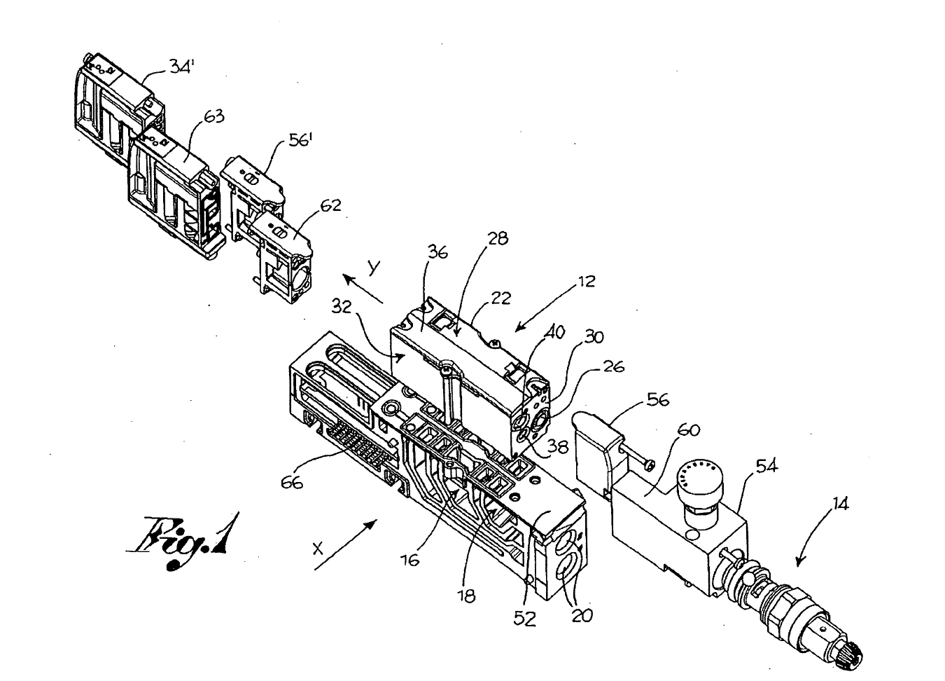

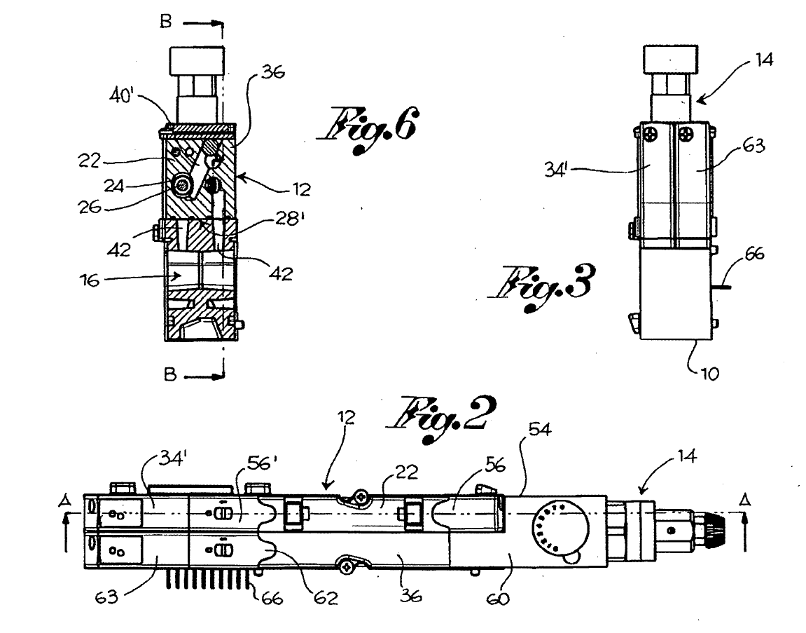

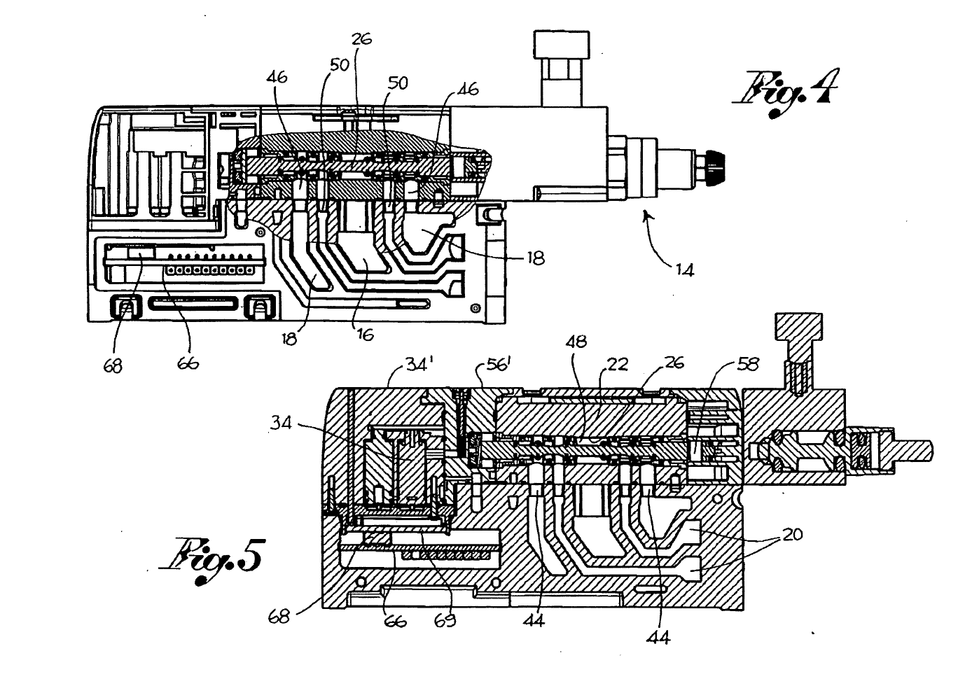

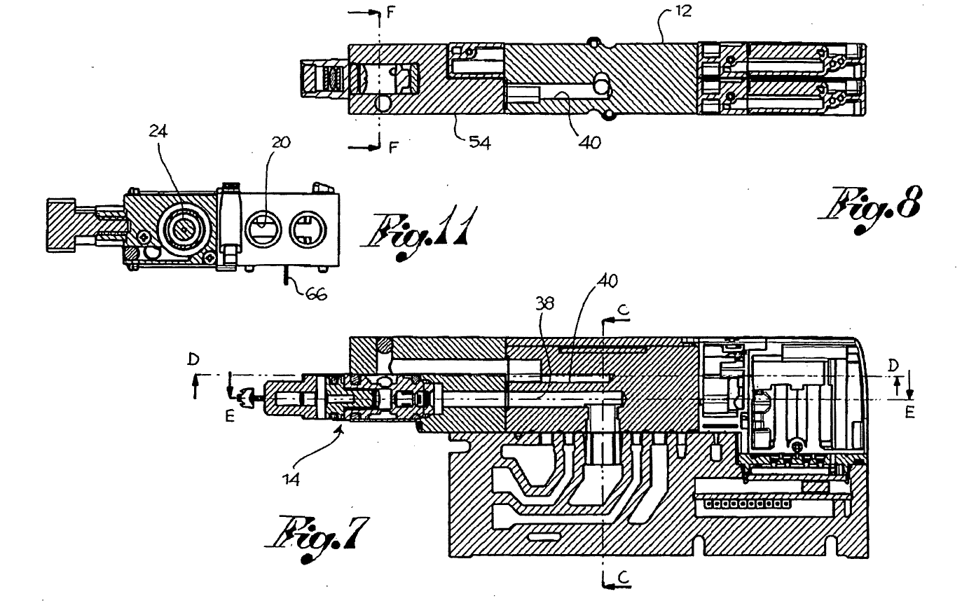

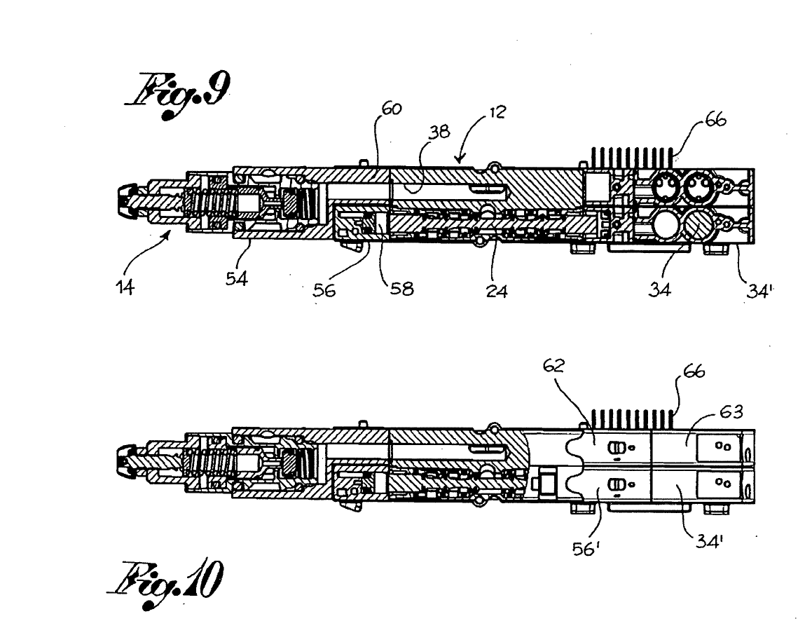

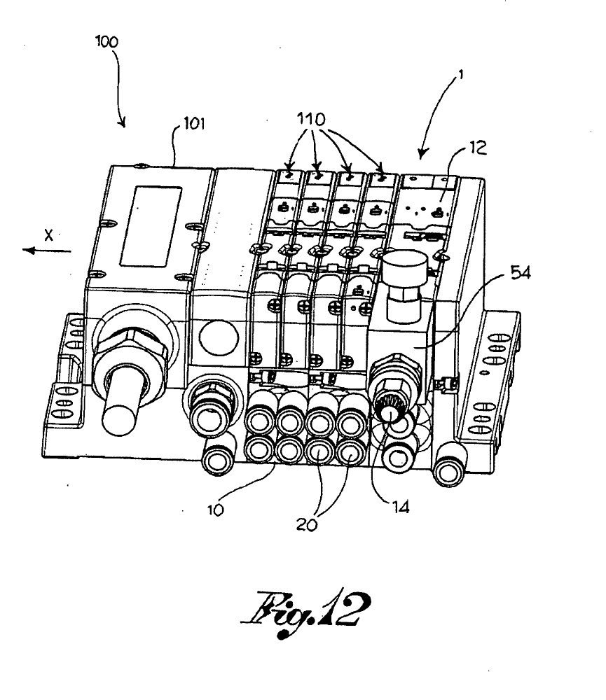

With reference to the above figures, reference numeral 1 indicates a valve device in accordance with the invention as a whole. In accordance with a general embodiment, the device 1 comprises a base 10, a valve body 12 which extends from the said base, and a pressure regulator 14.

In base 10 at least one feed conduit 16 that can be connected to a source of fluid under pressure and at least one discharge conduit 18 are provided.

In the embodiment illustrated by way of example in the figures, the valve device 1 is intended to be coupled with other valve devices 1 in such a way as to form valve island 100. In accordance with one embodiment of this island, bases 10 are suitable for being coupled and sealed and are connected for fluid conveyance to terminal unit 101 which receives fluid under pressure and distributes it to valve devices 1 of the island and conveys the discharge fluid from the valve devices.

So, in accordance with one embodiment, the feed and discharge conduits 16 and 18 cross each base 10 along direction X which is also the direction along which island 100 is developed.

Though valve device 1 in accordance with this invention is, for reasons that will be better explained below, particularly advantageous in valve island use, the invention is equally applicable to an independent valve where, for example, the feed conduits 16 and discharge conduits 18 are equipped with respective connections and tubes.

Valve device 1 includes at least one outlet conduit 20 that may be connected to its respective actuator, for example a pneumatic cylinder.

Valve body 12 comprises an interception portion 22 that defines a housing 24 which houses a sliding shuttle valve element 26. This shuttle valve element 26 extends and is movable along longitudinal axis Y of the valve body (at right angles to axis X of the development of valve island 100) to control the connection between feed conduit 16 and at least one outlet conduit 20.

Considering for the sake of simplicity the valve device 1 oriented with the base downwards, the valve body 12 defines an upper surface 28 opposite the base, two side surfaces of extremity 30, and two opposite longitudinal surfaces 32 which extend between the said side surfaces 30.

The longitudinal surfaces 32 of valve body 12 are substantially linked to the length of shuttle valve element 26 and are generally more extensive with regard to the side surfaces 30. The latter determine the thickness of valve body 12, which is to say its extension in direction X at right angles to the longitudinal extension along direction Y.

Valve device 1 further includes at least one pilot valve 34 which controls a pilot fluid fed by the fluid source and which is such as to have an axial action on shuttle valve element 26.

The pressure regulator 14 regulates the pressure of the fluid from feed conduit 16 in such a way as to convey fluid to outlet conduit 20, when opened by shuttle valve element 26, at a regulated pressure, different from the fluid pressure incoming to the valve device, for example mains pressure.

Pressure regulator 14 extends from one of the side surfaces 30 of the valve body, and in particular extends prevalently along a direction parallel to longitudinal axis Y.

Valve body 12 also includes a regulation portion 36 which extends parallel to and at the side of interception portion 22, between the latter and one of the longitudinal surfaces 32 of valve body 12. In other words interception portion 22, which carries out the function of valve body, and regulation portion 36, slave to regulator 14, are separated, at least from a geometrical viewpoint, by a vertical plane, which is to say at right angles to upper surface 28 of valve body 12. In yet other words, positioning at the side of interception portion 22 means that regulation portion 36 is oriented in such a way as to follow the direction X of valve island 100.

In regulation portion 36 there are a delivery passage 38, which links feed conduit 16 of the base with regulator 14, and a return passage 40 which from regulator 14 conveys the fluid at regulated pressure to housing 24 of valve element 26.

In accordance with a favoured embodiment, regulation portion 36 of valve body 12 faces and is in fluidic communication with a corresponding portion of base 10. In other words base 10 also extends in correspondence to regulation portion 36 to supply delivery passage 38 with fluid under pressure to regulator 14.

In accordance with this embodiment the base 10 has, in correspondence to regulation portion 36, an inlet port 42 which connects feed conduit 16 with delivery passage 38 of regulation portion 28 of the valve body and, in correspondence to interception portion 22, at least one discharge port 44 which connects discharge chamber 46 of housing 24 of the shuttle valve element 26 with a respective discharge conduit 18 of the base.

In accordance with one embodiment the base 10 also has at least one outlet conduit 20 communicating with a respective outlet chamber 48 of the valve housing 24 by means of a respective outlet port 50.

In accordance with a favoured embodiment, regulation portion 36 has a thickness equal to that of interception portion 22. In other words, valve body 12 has a thickness along axis X equal to double the thickness of an analogous valve device without pressure regulator 14.

This solution is particularly advantageous when the valve device is used in valve island 100. In fact valve device 1 in accordance with the invention occupies exactly the space of two valve devices 110 (see FIG. 12) of the same capacity but without pressure regulator 14. So it may be inserted in any point of the valve island 100 without influencing the layout of the other devices. Alternatively, valve device 1 occupies the same space and is perfectly interchangeable with a valve device without regulator and with a thickness along axis X, and therefore a capacity, equal to double those of valve devices 110.

In accordance with a favoured embodiment, valve body 12 is in a single piece. In other words, interception portion 22 and regulation portion 36 are separated, only from a functional viewpoint, by a median vertical plane. Alternatively, interception portion 22 and regulation portion 36 are obtained from distinct bodies and sealed together.

Advantageously, in both cases, valve body 12 is a parallelepiped with side surfaces 30, longitudinal sides 32 and upper side 28 flat and at right angles to each other. In other words, the interception (22) and regulation (36) portions are of the same height and length (along axis Y).

In accordance with one embodiment, valve body 12 is removably fixed to base 10. A sealing element 52 may be provided between body 12 and base 10.

Alternatively, valve body 12 and base 10 may be obtained from a single piece.

Advantageously, regulator 14 comprises a body 54 of the same thickness as valve body 12, in such a way as to take the form of a lateral continuation of the latter. In greater detail and in a favoured embodiment, between interception portion 22 of valve body 12 and pressure regulator 14 there is a valve body bottom 56 which houses pilot chamber 58 of shuttle valve element 26. In the case of valve body 12 with lateral surfaces 30 flat, then the body 54 of pressure regulator 14 has an appendage 60 linking it to the lateral surface of regulation portion 36, said appendage occupying the same volume of space as valve body bottom 56. In other words, body 54 of pressure regulator 14 is L-shaped in such a way as to offset the presence of valve body bottom 56 between valve body 12 and regulator 14.

Going back to regulation portion 36 of valve body 12, the return passage 40 extends in the said portion 36 parallel to housing 24 of shuttle valve element 26 (i.e. longitudinal direction Y) and has a terminal part 40′ which disembogues in the said housing 24, perpendicularly to the latter. Moreover, in accordance with a favoured embodiment that permits the obtaining of a thickness of regulation portion 36 which is at the most equal to that of regulation portion 22, the return passage 40 is obtained parallel to and above delivery passage 38. The terminal part 40′ of return passage 40 disemboguing in housing 24 of valve element 26, which is substantially at the same height as delivery passage 38, is therefore inclined downwards.

In accordance with one embodiment, at the extremity of interception portion 22 opposite regulator 14 there are, fixed in succession, a further valve body bottom 56′ containing a pilot chamber 58′ of shuttle valve element 26 and a housing 34′ containing at least one pilot valve 34.

Advantageously, at the extremity of regulation portion 36 opposite the regulator there are fixed, in succession, two box elements 62, 63 which respectively simulate valve body bottom 56′ and container 34′ for pilot valve 34 associated with interception portion 22. In practice the box elements 62 and 63 utilise the same bodies as the bottom 56′ and the container 34′, but internally they are empty. So if we exclude pressure regulator 14, valve device 1 occupies exactly the same volume of space and is substantially indistinguishable externally from the coupling of two valve devices 110 without pressure regulator, put together for example to form valve island 100, or from a valve device that is double the thickness of devices 110.

Furthermore, in accordance with a favoured embodiment, base 10 extends below and within the volume occupied by valve body 12 and, from the part opposite 14, beneath the bottom 56′ of container 34′ and box elements 62 and 63, which extend from regulation portion 36.

Advantageously, the base portion beneath at least one pilot valve 34 houses electrical connections 66, e.g. a printed circuit, to power the said pilot valve. In cases in which base 10 is suitable for coupling with the base of at least one other valve device to constitute valve island 100, the electrical connection 66 emerge from base 10 along direction X of the development of island 100 in such a way as to be connected to the electrical connections 66 of adjacent bases.

Advantageously, associated with at least one pilot valve 34, there is a power supply printed circuit board 69 with electrical contacts 68 facing the base and suitable for transmitting to the pilot valve power supply printed circuit board 69 the electrical signal from electrical connections 66 in base 10.

Going back now to the valve island 100 shown in FIG. 12, this island comprises a plurality of valve devices, at least one of which is device 1 in accordance with the invention, supplied with pressure regulator 14.

In accordance with one embodiment, valve devices comprising valve body and base (fully integrated or in respectively distinct bodies) are set side by side and fixed at least at the bases. Alternatively, island 100 comprises a single base on which at least two valve bodies are mounted. In turn, several islands of this type can be united to form an island with a high number of valve devices.

As mentioned above, the valve device 1 in accordance with a preferred embodiment of the invention occupies exactly the thickness of two valve devices 110 of the same capacity but without regulator, or of a valve device of double capacity. For example, without altering base 10 it is possible to replace the valve body of a double capacity valve device without regulator, with device 1 equipped with regulator 14 but with a halved capacity.

Advantageously, as a base 10 for device 1 it is therefore possible to use an existing base suitable for mounting two valve bodies of equal capacity, as in the example shown, or one valve body of double capacity.

It should be noted that base 10 has two identical parallel rows of feed ports 42, discharge ports 44 and outlet conduits 50. The valve body 12 has a lower surface 28′ facing base 10 which, in correspondence to the interception portion 22, closes the feed port 42 (since the incoming fluid must be conveyed first to the regulator by way of the regulation portion 36), and in correspondence to the regulation portion closes all the ports except the feed 42 which flows into the delivery conduit 38.

Advantageously, valve body 12, occupying the same volume in height as a standard valve body, i.e. one without a pressure regulator, means that at least one pilot valve 34 can be directly connected to the electrical connections 66 contained in base 10, without the need for electrical bridges or adapters, which is not the case with state of the art devices.

A pressure regulator 14 which does not require any increase in height volume of the valve island means that the latter can be mounted in small spaces or containers.

To the above described embodiments of the invention, a person skilled in the art could carry out modifications, adaptations and replacement of elements with functionally equivalent ones in order to meet contingent needs, yet without going beyond the scope of protection of the following claims. Each of the features described as belonging to a possible embodiment may be implemented independently of the other embodiment described.

What is claimed is:

1. Valve device, comprising:
a base in which at least one feed conduit connectable to a source of fluid under pressure and at least one discharge conduit are provided;
at least one outlet conduit connectable to an actuator;
a valve body which extends from the base and includes an interception portion defining a housing for a sliding shuttle valve element which is movable along longitudinal axis (Y) of the valve body to control fluidic connection between the feed conduit and at least one outlet conduit, where said valve body defines an upper surface opposite the base, two lateral extremity surfaces, which determine valve body thickness, and two opposite longitudinal surfaces, which extend between said lateral surfaces;
at least one pilot valve which controls a pilot fluid supplied from the fluid source and suitable for acting on the shuttle valve element; and
a pressure regulator to regulate the pressure of the fluid incoming from the feed conduit,
wherein
the pressure regulator extends from one of the said lateral surfaces of valve body, and wherein
said valve body also includes a regulation portion that extends parallel to and at the side of the interception portion, between the latter and one of the longitudinal surfaces of the valve body, in said regulation portion a delivery passage, which links the base feed conduit with the regulator, and a return passage, which from the regulator conveys the regulated pressure fluid to the housing of the valve element, being provided.

2. Valve device according to claim 1, in which the regulation portion of the valve body faces and is in fluidic communication with a corresponding portion of the base.

3. Valve device in accordance with claim 1, in which the regulation portion has a thickness equal to that of the interception portion.

4. Valve device according to claim 1, in which the valve body is made in a single piece.

5. Valve device according to claim 1, in which interception portion and regulation portion are provided in respective separate bodies airtightly placed side by side so as to form the valve body.

6. Valve device according to claim 1, in which the thickness of the base is equal to that of the valve body.

7. Valve device according to claim 1, in which the pressure regulator comprises a body whose thickness is equal to that of the valve body.

8. Valve device according to claim 1, in which between the interception portion of the valve body and the regulator there is a valve body bottom which houses pilot chamber of the shuttle valve element, and in which the body of the pressure regulator has an appendage linking it to the regulation portion, said appendage having the same size as the valve body bottom.

9. Valve device according to claim 1, in which the return passage extends in the regulation portion parallel to housing of the shuttle valve element and has a terminal part which disembogues in said housing, perpendicularly to the latter.

10. Valve device in accordance with claim 9, in which the return passage from the regulator is provided within the regulation portion parallel to and above the delivery passage, the terminal part of the return passage disemboguing in the housing of the shuttle valve element being inclined downwards.

11. Valve device according to claim 1, in which the valve body is removably fixed to the base.

12. Valve device according to claim 1, in which the at least one outlet conduit is obtained in the base.

13. Valve device according to claim 1, in which the regulation portion is of the same height and length as the interception portion.

14. Valve device in accordance with claim 13, in which at the extremity of the interception portion opposite the regulator there are fixed, in succession, a valve body bottom which contains the pilot chamber of the shuttle valve element and a housing for at least one pilot valve.

15. Valve device in accordance with claim 14, in which at the extremity of the regulation portion opposite the regulator there are fixed, in succession, two box elements which respectively simulate the valve body bottom and the housing for the pilot valve associated with the interception portion.

16. Valve device in accordance with claim 15, in which the base extends below and within the volume occupied by the valve body and, from the part opposite the regulator, below the valve body bottom, the pilot valve housing and the box elements that extend from the regulation portion.

17. Valve device according to claim 1, in which at least the base is suitable for coupling with the base of at least one other valve device to constitute a valve island.

18. Valve device in accordance with claim 16, in which the portion of the base beneath at least one pilot valve houses electrical connections for powering said pilot valve.

19. Valve device in accordance with claim 18, in which at least one pilot valve is associated with an electrical supply printed circuit board equipped with electrical contacts facing downwards and suitable for transmitting to the pilot valve printed circuit board the electrical signal from the electrical connections in the base.

20. Valve island comprising at least two valve devices side by side, at least one of which is a valve device in accordance with claim 1.

21. Valve island in accordance with claim 20, in which the bases of the valve devices are integrated.

22. Valve island in accordance with claim 20, in which each valve device with pressure regulator occupies, with regard to axis (X) of the island, a volume of space equal to double that of a valve device of the same capacity but without regulator.

23. Valve island in accordance with claim 22, in which the base of the valve device with pressure regulator is identical to the base of a valve device of double capacity but without pressure regulator, and in which the body of the valve device with pressure regulator is interchangeable with the body of the same double capacity valve device, the base remaining the same.
